(19) United States
(12) Patent Application Publication
(10) Pub. No.: US 2011/0261925 A1
(43) Pub. Date: Oct. 27, 2011

(54) GRID APPARATUS AND X-RAY DETECTING APPARATUS

(75) Inventors: Dong-Sik KIM, Seongnam-si (KR); Sang-Gyun LEE, Yongin-si (KR); Beom-Jin MOON, Suwon-si (KR); Jung-Kee YOON, Anyang-si (KR)

(73) Assignee: DRTECH Corporation, Seongnam-si (KR)

(21) Appl. No.: 12/897,482

(22) Filed: Oct. 4, 2010

(30) Foreign Application Priority Data
Apr. 26, 2010 (KR) 10-2010-0038665
Sep. 8, 2010 (KR) 10-2010-0087988

(51) Int. Cl. G01N 23/06

(52) U.S. Cl. 378/19

(57) ABSTRACT

A grid apparatus of an X-ray detecting apparatus is provided. The grid apparatus includes an X-ray absorbing material for absorbing X-rays that are scattered from an object, and an X-ray passing material formed between the X-ray absorbing materials to allow X-rays to pass therethrough. The X-ray absorbing material and the X-ray passing material form a line pattern forming a predetermined angle with a line pattern of pixels of an X-ray detector. The grid apparatus enables simpler implementation of a grid noise reduction algorithm and reduces the time and labor for reducing grid noise.

### CROSS-REFERENCE TO RELATED APPLICATION

This application claims the benefit under 35 U.S.C. §119(a) of Korean Patent Applications No. 10-2010-0038665, filed on Apr. 26, 2010, and No. 10-2010-0087988, filed on Sep. 8, 2010, the disclosures of which are incorporated by reference in its entirety for all purposes.

### BACKGROUND

1. Field

The following description relates to an X-ray detecting apparatus, and more particularly, to a grid apparatus of an X-ray detecting apparatus.

2. Description of the Related Art

With the development of the digital industry, more and more medical imaging equipment has been implemented in a digital manner. As a result, digital radiography (DR) of capturing X-ray images in a digital manner has become more actively developed. In addition, in order to improve diagnosis the ability of the medical imaging equipment, high quality X-ray images need to be detected.

FIG. 1 is a view showing a conventional digital X-ray detecting system. An X-ray radiator 10 is configured to radiate a conical beam type X-rays to an object according to a control signal.

An X-ray detector 16 of the X-ray detecting system receives X-rays passing through the object and outputs a photographic image based on the received X-rays to a display.

In this case, the X-ray detector 16 is provided with photodetectors arranged in the form of a matrix, and an X-ray grid 14 is installed before of the X-ray detector 16 to absorb X-rays scattered from the object. The X-ray grid 14 prevents the scattered X-rays from being detected by another photodetector adjacent to an intended photodetector and serving as noise. In this manner, the degradation of contrast of X-ray images due to noise is resolved.

In general, the X-ray grid 14 is formed by stacking an X-ray absorbing material and an X-ray transmitting material into a plurality of layers and cutting the stacked layers transversely.

Because the number of process line strips of the grid 14 is limited and the frequency of the grid line strips does not match the frequency of the pixels of the X-ray detector 16, the grid line may overlap the pixel of the X-ray detector, causing the grid line to be visible on the X-ray image. In addition, the frequency of the grid line is different from the frequency of the pixel of the photodetector, causing a moire pattern due to an aliasing effect of grid lines. In particular, for the case of a direct X-ray detector providing a high solution image, such a representation of grid lines or the moire phenomenon is more noticeable.

A representative scheme suggested to solve the above problems is a moving grid scheme in which a grid is momentarily oscillated while X-rays are being radiated such that a grid line is obscured.

However, in the X-ray imaging using a digital X-ray detector, it is difficult to block electromagnetic waves generated by a motor for oscillating the grid. In addition, the X-ray imaging using a digital detector requires an additional component, for example, a motor, thus increases the implementation cost and complicates the system configuration. Accordingly, the labor and cost for maintenance of the X-ray imaging system are increased. For this reason, a technology of interpolating an image in a fixed grid scheme is required.

### SUMMARY

In one aspect, there is provided a grid apparatus and an X-ray detecting apparatus, capable of achieving high quality imaging in a fixed grid scheme.

In another aspect, there is provided a grid apparatus and an X-ray detecting apparatus, capable of offering simpler implementation of a grid noise reduction algorithm.

In one general aspect, there is provided a grid apparatus including at least one X-ray absorbing material for absorbing X-rays that are scattered from an object, and at least one X-ray passing material formed between the X-ray absorbing materials to allow X-rays to pass therethrough. The X-ray absorbing material and the X-ray passing material form a line pattern forming a predetermined angle with a line pattern of pixels of an X-ray detector.

In another general, there is an X-ray detecting apparatus including an X-ray detector and a grid which is attachable to the X-ray detector. The X-ray detector includes photodetectors arranged in a form of a matrix. The grid includes at least one X-ray absorbing material for absorbing X-rays that are scattered from an object, and at least one X-ray passing material formed between the X-ray absorbing materials to allow X-rays to pass therethrough, wherein the is X-ray absorbing material and the X-ray passing material form a line pattern forming a predetermined angle with a line pattern of X-ray detector pixels.

The present invention can provide simpler implementation of the noise reduction algorithm and reduce the time and labor for reducing grid noise.

In addition, the present invention can provide an X-ray projected image producing a less distorted photographic image.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a view showing a conventional digital X-ray detecting system.

FIG. 2 is a view showing an example of a grid apparatus.

FIGS. 3A and 3B are views describing an effect of the grid apparatus shown in FIG. 1.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

Hereinafter, detailed examples will be described with reference to the accompanying is drawings.

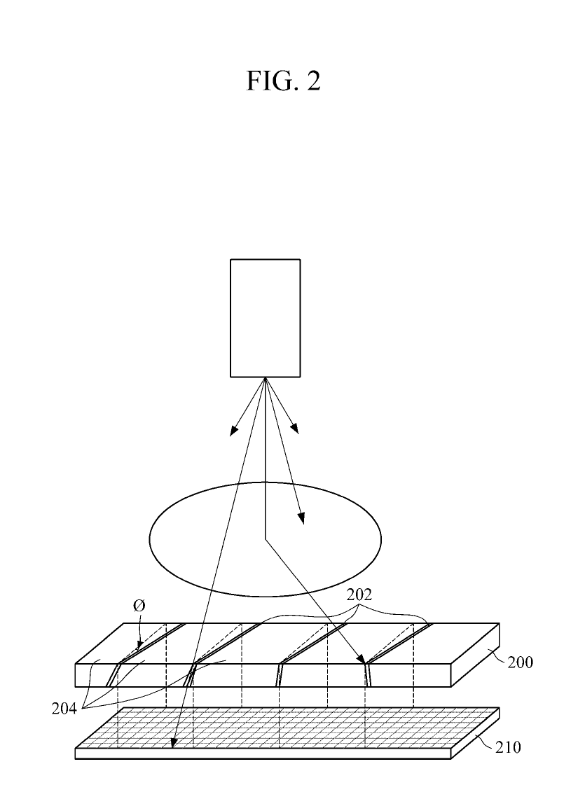

FIG. 2 is a view showing an example of a grid apparatus.

A grid apparatus 200 according to an example of the present invention includes at least one X-ray absorbing material 204 for absorbing X-rays that are scattered from an object, and at least one X-ray passing material 202 formed between the X-ray absorbing materials to allow X-rays to pass therethrough. The X-ray absorbing material 204 and the X-ray passing material 202 form a line pattern forming a predetermined angle with a pixel of an X-ray detector.

The X-ray absorbing material 204 is used to absorb X-rays scattered from an object to prevent the X-rays from reaching the X-ray detector. The X-ray absorbing material 204 is provided in the form of a line pattern on a substrate. As an example, the X-ray absorbing material 204 includes any one selected from the group consisting of lead, bismuth, gold, barium, tungsten, platinum, mercury, indium, thallium, palladium, tin, zinc and an alloy thereof. However, the material forming the X-ray absorbing material 204 is not limited thereto.

The X-ray passing material 202 is interposed between the X-ray absorbing materials 204 to allow X-rays to pass therethrough. As an example, the X-ray passing material 202 includes any one selected from the group consisting of plastic, polymer, ceramic, graphite and carbon fiber.

As shown in FIG. 2, the X-ray absorbing material 204 and the X-ray passing material 202 are alternately provided in the form of a line.

In the description of the embodiment, the term ‘acquisition image’ will be regarded to as including an original image and a noise image. The acquisition image represents an image obtained from an X-ray detecting apparatus, and the original image represents an image which is obtained after removing the noise image from the acquisition image. That is, the original image is a final image to be obtained by the X-ray detecting apparatus. The noise image is an image including noise generated when an X-ray beam passes through the grid apparatus. The noise is generated when an X-ray beam passes through the grid apparatus includes noise due to the line pattern of the grid apparatus and noise due to the scattering of an x-ray beam which passes through an object.

The line patterns of the X-ray absorbing material 204 and the X-ray passing material 202 form an angle Φ with the line pattern of matrix-shaped photodetectors of an X-ray detector 210.

In this example, Φ may vary depending on the pixel size of the photodetectors of the X-ray detector 210 and the interval between the line patterns formed by the X-ray absorbing material 204 and the X-ray passing material 202. The extension direction of the line pattern of the grid apparatus 200 is not limited as long as the line pattern of the grid apparatus 200 forms the angle Φ with the line pattern of the photodetectors. When Φ is 10 to 40 degrees, a frequency corresponding to a noise image is disposed farthest away from a frequency corresponding to an original image or close to the boundary in a frequency domain.

Equation 1

f1=fs/2cosΦ

Here, f1 represents the line density of the grid apparatus 200, fs represents sampling frequency of detector and Φ represents an angle formed between a line pattern of the grid apparatus 200 and a line pattern of the X-ray detector 210.

For example, if the angle Φ is 26.6 degrees and the sampling frequency fs is 7.194, the line density of the grid apparatus 200 is 4.022 (102 lines/inch). That is, the grid apparatus 200 has an angle of 26.6 degrees and a line density f1 of 102 lines/inch.

The present invention suggests an algorithm capable of preventing frequency data corresponding to a desired image from being removed when removing the frequency of an image of a fixed grid. According to an example of the present invention, if a matrix-form line pattern of the X-ray detector 210 forms a predetermined angle with respect to a line pattern of the grid is apparatus 200, the frequency corresponding to a noise image is distant from the frequency of an original image by a predetermined distance or above in a frequency domain. In the most preferable case, the frequency of the noise image is positioned close to the boundary of the frequency domain, so the degradation of the original image is minimized when the frequency of the noise image is removed.

An example of an X-ray detecting apparatus includes the grid apparatus 200 described above. In addition, the X-ray detecting apparatus further includes the X-ray detector 210 and a one-dimensional low pass filter (LPF).

The X-ray detector 210 receives X-rays passing through an object, acquires an image (hereinafter, referred to as an acquisition image) based on the received X-rays and outputs the acquisition image to a display. The grid apparatus 200 is attachable to the X-ray detector 210. The one-dimensional LPF may be a butterworth filter or a mean filter.

In removing the grid image using the one-dimensional low pass filter, an acquisition image output from the X-ray detector 210 is filtered with respect to the direction of an X-axis and then filtered with respect to the direction of a Y-axis.

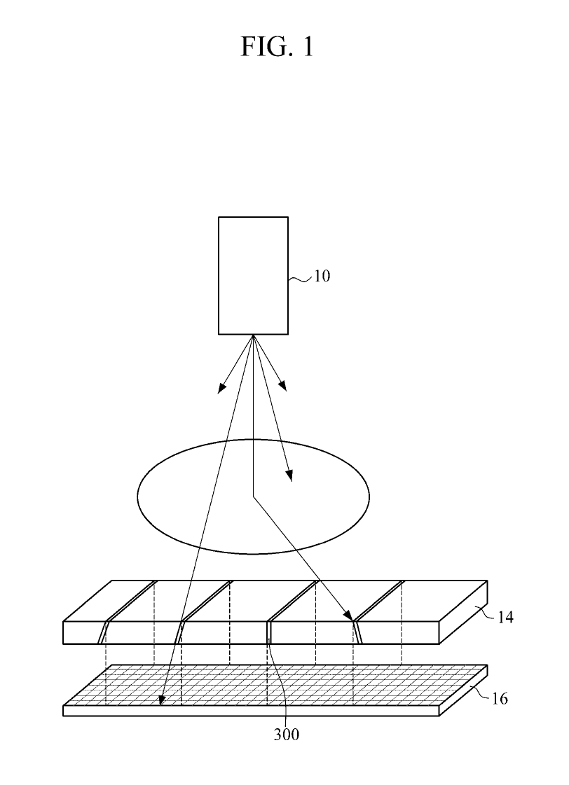

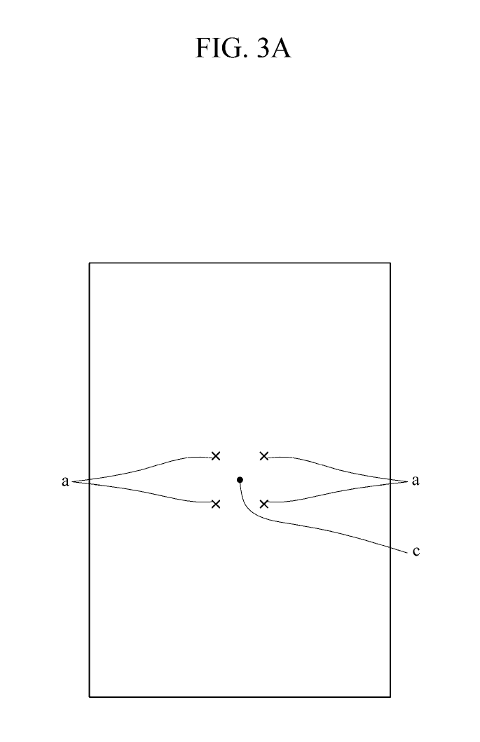

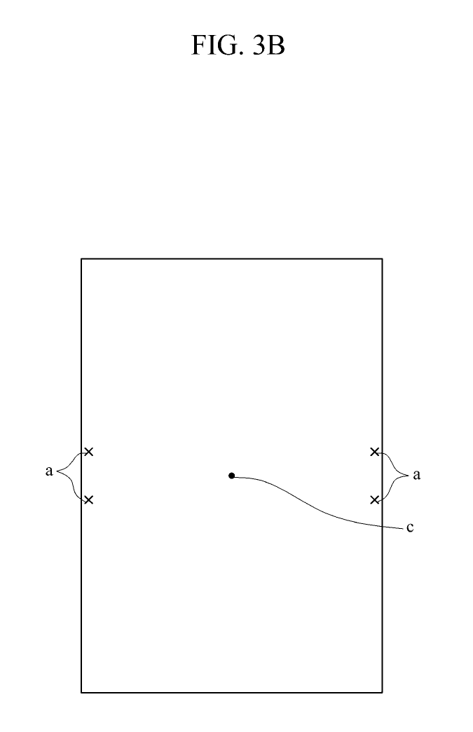

FIGS. 3A and 3B are views used to describe an effect of the grid apparatus shown in FIG. 1.

FIG. 3A shows a Fourier transform result of an acquisition image including a general grid image. FIG. 3B shows a Fourier transform result of an acquisition image including a grid image that is obtained by the grid apparatus 200 according to the present invention.

Referring to FIG. 3A, the frequency (c) corresponding to an original image and the frequency (a) corresponding to a noise image gather at the center (the origin) of a frequency domain. Accordingly, in order remove the noise image from the acquisition image, the acquisition image is transformed to correspond to the frequency domain, the maximum value of is the acquisition image in the frequency domain is found, and then the acquisition image is filtered using a Notch filter, a Gaussian filter and a spatial-frequency filter. Thus, it involves complicated operation processes.

Meanwhile, referring to FIG. 3B, the frequency (c) corresponding to an original image is positioned at the center and the frequency (a) corresponding to a noise image obtained using the grid apparatus 200 is positioned near to the boundary of the frequency domain. Accordingly, by only performing a Fourier transform on the image detected by the X-ray detector 210 and using a band pass filter (BPF), the frequency b corresponding to the noise image is simply removed. According to one example, the frequency corresponding to the noise image is removed by applying a one-dimensional low pass filter (LPF) to the image detected from the X-ray detector 210. The one-dimensional LPF may be a butterworth filter or a mean filter.

In this case, filtering is performed with respect to the direction of an X-axis and then filtered with respect to the direction of a Y-axis in a spatial domain.

In this regard, according to the present invention, the center frequency of grid artifact is found without having to use a complicated frequency estimation algorithm, and a Fourier transform and inverse Fourier transform for two-dimensional filtering requiring intensive computation. That is, as described above, the noise image is rapidly removed through a simple algorithm using a one-dimensional low pass filter in a state that the degradation of the original image is minimized.

Also, functional programs, codes, and code segments for accomplishing the present invention can be easily construed by programmers skilled in the art to which the present invention pertains. A number of exemplary embodiments have been described above. Nevertheless, it will be understood that various modifications may be made. For example, suitable results may be achieved if the described techniques are performed in a different order and/or if components in a described system, architecture, device, or circuit are combined in a is different manner and/or replaced or supplemented by other components or their equivalents. Accordingly, other implementations are within the scope of the following claims.

What is claimed is:

1. A grid apparatus comprising:
at least one X-ray absorbing material for absorbing X-rays that are scattered from an object; and
at least one X-ray passing material formed between the X-ray absorbing materials to allow X-rays to pass therethrough,
wherein the X-ray absorbing material and the X-ray passing material form a line pattern forming a predetermined angle with a line pattern of pixels of an X-ray detector.

2. The grid apparatus of claim 1, wherein the X-ray absorbing material and the X-ray passing material form a line pattern forming an angle of 10 to 40 degrees with the line pattern of the pixels of the X-ray detector.

3. The grid apparatus of claim 1, wherein the line pattern of the grid apparatus has a density which is calculated based on a sampling frequency and the predetermined angle.

4. An X-ray detecting apparatus comprising:
an X-ray detector including photodetectors arranged in a form of a matrix; and
a grid including at least one X-ray absorbing material for absorbing X-rays that are scattered from an object, and at least one X-ray passing material formed between the X-ray absorbing materials to allow X-rays to pass therethrough, wherein the X-ray absorbing material and the X-ray passing material form a line pattern forming a predetermined angle with a line pattern of X-ray detector pixels,
wherein the grid is attachable to the X-ray detector.

5. The X-ray detecting apparatus of claim 4, wherein the X-ray absorbing material and the X-ray passing material form a line pattern forming an angle of 10 to 40 degrees with the line pattern of the X-ray detector pixels.

6. The X-ray detecting apparatus of claim 5, wherein the line pattern of the grid has a density which is calculated based on a sampling frequency and the predetermined angle.

7. The X-ray detecting apparatus of claim 4, further comprising a one dimensional low pass filter (LPF) for removing a grid artifact image from an image that is detected from the X-ray detector.
